(19) United States
(12) Patent Application Publication
(10) Pub. No.: US 2013/0011760 A1
(43) Pub. Date: Jan. 10, 2013

(54) FUEL CELL STACK STRUCTURE

(75) Inventors: Suk Min Baeck, Seongnam (KR); Sae Hoon Kim, Yongin (KR); Yoo Chang Yang, Gunpo (KR); Sang Mun Jin, Seoul (KR); Seong Il Heo, Yongin (KR); Chi Seung Lee, Yongin (KR)

(73) Assignees: KIA MOTORS CORPORATION, Seoul (KR); HYUNDAI MOTOR COMPANY, Seoul (KR)

(21) Appl. No.: 13/313,849

(22) Filed: Dec. 7, 2011

(30) Foreign Application Priority Data
Jul. 6, 2011 (KR) 10-2011-0066784

(51) Int. Cl. H01M 8/04; H01M 8/00

(52) U.S. Cl. 429/433; 429/535

(57) ABSTRACT

Disclosed herein is a fuel cell stack structure, including: metallic bipolar plates having cooling surfaces facing each other, wherein film-removed portions are provided at portions of the cooling surfaces. The fuel cell stack structure is advantageous in that electrical conductivity can be achieved by the contact portion of two metallic bipolar plates without having to apply a conductive material onto the contact site of the cooling surfaces of the metallic bipolar plates, so that the manufacturing cost of the metallic bipolar plate can be reduced, thereby reducing the manufacturing cost a fuel cell stack.

### CROSS-REFERENCE TO RELATED APPLICATIONS

This application claims under 35 U.S.C. §119(a) priority to Korean Application No. 10-2011-0066784, filed on Jul. 6, 2011, the disclosure of which is incorporated herein by reference in its entirety.

### BACKGROUND OF THE INVENTION

1. Technical Field

The present invention relates to a fuel cell stack structure, and, more particularly, to a metallic separating (“bipolar”) plate structure constituting each fuel cell.

2. Description of the Related Art

FIG. 1 is a sectional view showing a conventional fuel cell stack structure in which the fuel cells are stacked. As shown in FIG. 1, a laminate 500 includes a membrane electrolyte assembly (MEA) and gas diffusion layers (GDLs) attached to both sides of the membrane electrolyte assembly (MEA). A metallic separating plate 502 disposed beneath the laminate 500 provides a fuel (hydrogen) supply passage and constitutes an anode. A metallic separating plate 502 disposed on the laminate 500 provides an air (oxidant) supply passage and constitutes a cathode. As shown, this structure forms a unit fuel cell 504. A plurality of such unit fuel cells are stacked to form a fuel cell stack.

The unit fuel cells 504, as shown in FIG. 1, are stacked such that the metallic separating plate 502 constituting an anode comes into contact with the metallic separating plate 502 constituting a cathode. These two metallic separating plates 502 (also referred to as metallic bipolar plates, and, thus, these terms may be used interchangeably) are configured such that they are bent to allow cooling water to flow through passages formed between the bent portions, and such that the generated electric current flows through the portions of the two metallic separating plates 502 in contact with each other.

For reference, of the two sides of the metallic separating plate 502, the side forming the cooling water passages and the contact portions is defined as “a cooling surface 506”.

The metallic separating plate 502 is typically made of stainless steel. However, a passivation film spontaneously forms on the surface of this stainless steel plate. Thus, if the stainless steel metallic separating plate 502 is not surface-treated, the contact resistance of its contact portion increases which decreases the efficiency of the system. Therefore, as shown in FIG. 1, both sides of the metallic separating plate 502 are coated with a conductive material, such as precious metal, carbon or the like, so that there is a reduction in power loss as a result of the electrical resistance that occurs when the generated electric current flows, and so that heat generation can be reduced.

However, the conventional cell stack structure is problematic in that, when the surface of the metallic separating plate 502 is coated with a conductive material such as precious metal or the like, the manufacturing cost of the metallic separating plate 502 increases, thus greatly increasing the production cost of a fuel cell stack.

### SUMMARY OF THE INVENTION

Accordingly, the present invention has been devised to solve the above-mentioned problems, and an object of the present invention is to provide a fuel cell stack structure having reduced manufacturing costs. In particular, a fuel cell stack structure is provided which achieves electrical conductivity by the contact portion of two metallic bipolar plates without applying a conductive material onto the contact sites of the cooling surfaces, thus reducing the manufacturing cost of the metallic bipolar plate.

In order to accomplish the above object, an aspect of the present invention provides a fuel cell stack structure comprising: metallic bipolar plates having cooling surfaces that face each other, wherein film-removed portions are provided at the cooling surfaces.

Another aspect of the present invention provides a method of manufacturing a fuel cell stack, including the steps of: removing passivation films from cooling surfaces of metallic bipolar plates to form film-removed portions having electrical conductivity; stacking the metallic bipolar plates such that the cooling surfaces of the metallic bipolar plates face each other; and assembling the metallic bipolar plates by pressing the metallic bipolar plates such that the film-removed portions facing each other are attached to each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional fuel cell stack structure;

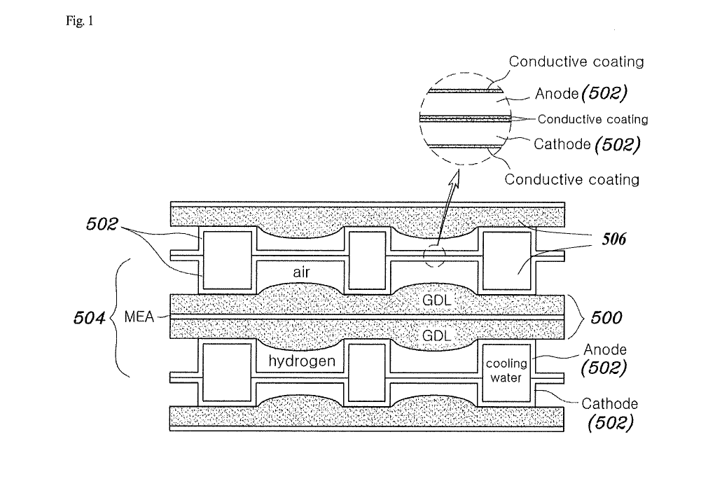

FIG. 2 is a sectional view showing a fuel cell stack structure according to an embodiment of the present invention; and

FIG. 3 is a flowchart showing a method of manufacturing a fuel cell stack according to an embodiment of the present invention.

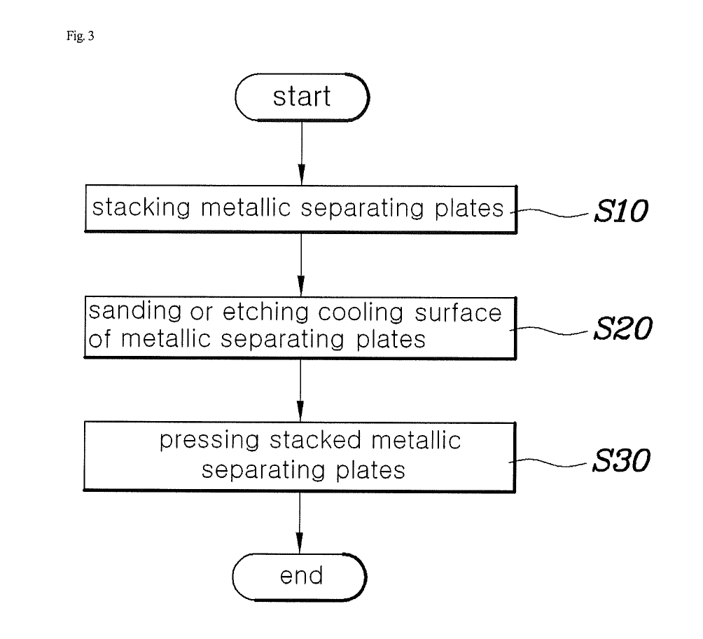

### DESCRIPTION OF THE PREFERRED EMBODIMENTS

Hereinafter, preferred embodiments of the present invention will be described in detail with reference to the attached drawings.

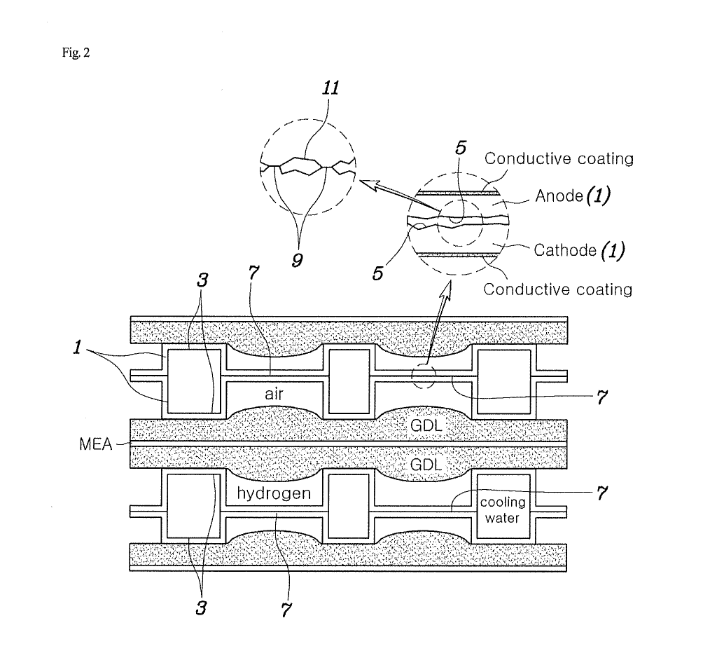

Referring to FIG. 2, a fuel cell stack structure according to an embodiment of the present invention includes metallic bipolar plates 1 having cooling surfaces 3 that face each other, wherein film-removed portions 5 are provided at the cooling surfaces.

In particular, nonconductive passivation films naturally formed on the cooling surfaces 3 of adjacent metallic bipolar plates 1 are removed by a sanding or chemical etching process, which is in contrast with a conventional conductive coating process, to form cooling water passages. These film-removed portions 5 having fine unevenness and electrical conductivity are located at the places from which the nonconductive passivation films have been removed.

The film-removed portions 5 of the adjacent metallic bipolar plates 1 form contact surfaces 7 that come into contact with each other. The unevennesses of the film-removed portions 5 forming the contact surfaces 7 are faced towards each other and pressed against each other to form contact portions 9 integrated with each other. The contact portions 9 formed in this way greatly reduce the electrical resistance between adjacent metallic bipolar plates 1, thus enabling electric current to easily flow between the adjacent metallic bipolar plates 1 without having to carry out a conductive coating process.

In particular, when the unevennesses of the film-removed portions 5 face each other at the contact surfaces 7 formed by bringing the film-removed portions 5 of adjacent metallic bipolar plates 1 into contact with each other, the film-removed portions 5 do not come into contact with air. This prevents the spontaneous formation of passivation films on the cooling surfaces 3 of adjacent metallic bipolar plates 1 at contact potions 9, thus forming the contact portions 9 which continuously maintain electric conductivity over time, while passivation films are spontaneously formed at the non-contact portions by the contact thereof with air over time.

In various embodiments, the film-removed portions 5 may be formed only at the contact surfaces 7 coming into contact with the cooling surfaces 3 of the adjacent metallic bipolar plates 1. In other words, unevenness may be partially formed (by the film-removed portions 5) at the portions of a metallic bipolar plate 1 coming into contact with another metallic bipolar plate 1 adjacent thereto. As such, the unevenness would be formed on both of the bipolar plates 1 at those portions which contact each other, while unevenness would not be formed in non-contact portions at which the cooling water passages will be formed.

In various other embodiments, the film-removed portions 5 may also be formed over the entire cooling surface 3 of each of the metallic bipolar plates 1. In this case, the contact portions 9, at which passivation films are not formed, are formed at the contact surface 7 coming into contact with another adjacent metallic bipolar plate 1 by the strong pressure applied between the adjacent metallic bipolar plates 1. In the exposed portions, such as the portions forming cooling water passages, spontaneous oxidization occurs over time so that the passivation films again form.

Of course, it would be understood by one of skill in the art that the film-removed portions 5 could also be formed such that they do not cover the entire cooling surface 3 of each of the metallic bipolar plates 1, but instead covers the entire contact surface(s) 7 the bipolar plates 1 and only a part of those non-contact portions forming cooling water passages.

Therefore, in accordance with various embodiments, it is preferred that the metallic bipolar plate 1 be made of a material that can be oxidized to form a passivation film. For example, the metallic separation plate 1 may be made of stainless steel.

According to various embodiments, the metallic bipolar plate 1 is formed by sanding or etching such that the surface roughness (Ra) thereof is about 1˜15 μm. Such surface roughness provides stable contact portions 9 having electrical conductivity that can be formed by the bonding force between the adjacent metallic bipolar plates 1.

Generally, although the unevenness of the metallic bipolar plate 1 can be formed by sanding or etching, it may also be formed by surface treatment as long as a nonconductive passivation film is removed from the metallic bipolar plate 1 and, at the same time, electrical conductivity is imparted to the metallic bipolar plate 1 by the surface treatment.

For example, the reaction surfaces of the metallic bipolar plates 1, which are opposite to the cooling surfaces 3 thereof, can be surface-treated with a conductive material, in accordance with conventional technologies.

Therefore, as described above, the method of manufacturing a fuel cell stack using the metallic bipolar plates 1, each being unevenly formed by removing a passivation film therefrom, includes the steps of: removing a passivation film from at least a portion of a cooling surface of each of the metallic bipolar plates 1 constituting the fuel cell stack to form a film-removed portion 5 having electrical conductivity (S10); stacking the metallic bipolar plates 1 such that the cooling surfaces 3 of the metallic bipolar plates 1 face each other (S20); and assembling the metallic bipolar plates 1 by pressing the metallic bipolar plates 1 such that at least portions of the film-removed portions facing each other are attached to each other (S30). As noted above, the film-removed portions 5 could be provided in some embodiments in both the contact portions as well as the non-contact portions (i.e. cooling water passages) and thus, only those film-removed portions 5 which constitute the contact portions are attached in step (S30). On the other hand, in other embodiments, the film-removed portions 5 are only formed on the contact portions and thus, the entire film-removed portions 5 would be attached in step (S30).

When a fuel cell stack is manufactured in this way, the fabrication cost of the metallic bipolar plate is reduced, thus reducing the manufacturing cost of the fuel cell stack, compared to when both sides of the metallic bipolar plate are coated with a conductive material such as precious metal or the like.

As described above, according to the present invention, electrical conductivity can be achieved by the contact portion of two metallic bipolar plates without applying a conductive material onto the contact site of the cooling surfaces of metallic bipolar plates, so that the manufacturing cost of the metallic bipolar plate can be reduced, thereby reducing the manufacturing cost a fuel cell stack.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fuel cell stack structure, comprising:
at least one pair of metallic bipolar plates having cooling surfaces that face each other; and
film-removed portions provided on at least a portion of the cooling surfaces.

2. The fuel cell stack structure according to claim 1,
wherein the film-removed portions have fine unevennesses formed by removal of a passivation film; and
wherein the film-removed portions of the pair of metallic bipolar plates are in contact with each other such that the film-removed portions do not come into contact with air to prevent passivation films from spontaneously forming on the film-removed portions in contact with each other, and wherein non-contact portions of the cooling surfaces are provided with passivation films that are spontaneously formed by the contact with air over time.

3. The fuel cell stack structure according to claim 2, wherein the film-removed portions in contact with each other form contact portions that continuously maintain electric conductivity over time.

4. The fuel cell stack structure according to claim 1, wherein the cooling surfaces of the pair of metallic bipolar plates are in contact with each other at contact surfaces, and wherein the film-removed portions are formed only at the contact surfaces.

5. The fuel cell stack structure according to claim 4, wherein portions of the cooling surfaces are not in contact with each other at non-contact surfaces, and wherein the non-contact surfaces are provided with passivation films.

6. The fuel cell stack structure according to claim 1, wherein the metallic bipolar plates further comprise a reaction surface opposite to the cooling surface thereof, and wherein the reaction surface is surface-treated with a conductive material.

7. The fuel cell stack structure according to claim 1, wherein the film-removed portion is formed by removing a passivation film from the metallic bipolar plate by sanding or chemical etching.

8. The fuel cell stack structure according to claim 1, wherein the film-removed portion has a plurality of fine unevennesses formed by removing a passivation film from the metallic bipolar plate by sanding or chemical etching; and the unevennesses are disposed at a contact surface between cooling surfaces of the pair of metallic bipolar plates.

9. The fuel cell stack structure according to claim 8, wherein the metallic bipolar plates have a surface roughness of about 1˜15 μm.

10. The fuel cell stack structure according to claim 1, wherein the film-removed portions formed at the cooling surfaces of the pair of metallic bipolar plates are pressed and attached to each other such that both the film-removed portions are in contact with each other.

11. A method of manufacturing a fuel cell stack, comprising the steps of:
removing passivation films from at least a portion of cooling surfaces of at least one pair of metallic bipolar plates to form film-removed portions having electrical conductivity (S10);
stacking the at least one pair of metallic bipolar plates such that the cooling surfaces of the pair of metallic bipolar plates face each other (S20); and
assembling the pair of metallic bipolar plates by pressing the pair of metallic bipolar plates such that the film-removed portions facing each other are attached to each other (S30).
